(19) United States
(12) Patent Application Publication
(10) Pub. No.: US 2023/0036951 A1
(43) Pub. Date: Feb. 2, 2023

(54) PROCESS FOR THE PREPARATION OF PROTEIN MASS

(71) Applicant: DEUTSCHES INSTITUT FUER LEBENSMITTELTECHNIK E.V., Quakenbrück (DE)

(72) Inventors: Sergiy Smetana, Quakenbrück (DE); Oleksii Pamiakov, Quakenbrück (DE)

(21) Appl. No.: 17/786,327

(22) PCT Filed: Dec. 17, 2020
(86) PCT No.: PCT/EP2020/086905

§ 371 Date: Jun. 16, 2022

(30) Foreign Application Priority Data
Dec. 17, 2019 (DE) 10 2019 219 928.3

(51) Int. Cl. A23K 10/20; A23J 1/00; A23L 33/17

(52) U.S. Cl. CPC A23K 10/20; A23J 1/00; A23L 33/17; A23V 2002/00

(57) ABSTRACT

The invention relates to a process for the production of a protein mass from insect larvae, comprising the steps of,
cleaning insect larvae,
applying pulsed electric fields to the cleaned insect larvae and comminuting the insect larvae to produce an insect mass; and
subsequently fractionating the insect mass into a solid and at least one liquid phase
with subsequent drying of the solid.

The present invention relates to a process for the production of a protein mass from insect larvae, which preferably are grown on plant-based remnants. The protein mass obtainable by the process is preferably dried at elevated temperature into particles or powder for use as a hygienic ingredient for food or feed.

The insect larvae are used raw, i.e. without initial heating to a protein denaturing temperature of, for example, 50° C. or higher in the process, so that the insect larvae are at least not thermally denatured.

The process is characterized by the fact that it can be carried out in an energy-efficient manner and produces a protein mass that is sensorially acceptable.

DE 10 20017 210 327 A1 describes the treatment of fruits and vegetables with pulsed electric fields to condition them for subsequent freeze-drying.

In general, insect larvae are known to be used raw or cooked as food.

The invention has the object of providing an alternative process, preferably an energy-efficient process, for producing protein mass from insects so that the protein mass is sensory acceptable. Further preferably, the process is to produce ingredients of the insects as completely as possible for use as food or feed.

The invention achieves the object by the features of the claims, in particular by a method comprising or consisting of the steps of
cleaning insect larvae,
applying pulsed electric fields to the cleaned insect larvae and comminuting the insect larvae to produce an insect mass; and
subsequent by fractionating the insect mass into a solid and at least one liquid phase
with subsequent drying of the solid to produce the protein mass.

In a first embodiment, the cleaned insect larvae are suspended in water and, while suspended in water, are subjected to pulsed electric fields. Subsequently, the insect larvae are comminuted, preferably including the step of separating the insect larvae from the water prior to comminution. In this embodiment, cleaning and applying pulsed electric fields to the insect larvae may be performed concurrently by suspending insect larvae in water and applying the pulsed electric fields to the insect larvae in the water. The insect larvae are then separated from the water and then comminuted.

In a second embodiment, the insect larvae are first comminuted and the obtained mass of comminuted insect larvae is subjected to pulsed electric fields. In this embodiment, the insect larvae are preferably separated from adhering water, for example originating from cleaning with water. Preferably, the insect larvae are dried at least superficially prior to comminution, and no water is added to the mass of comminuted insect larvae, so that the mass may consist exclusively of comminuted insect larvae. In the second embodiment, the process may consist of the steps of cleaning the insect larvae, preferably separating adhering water, optionally freezing, comminuting, subjecting to pulsed electric fields, fractionating into a solid phase and at least one liquid phase, and drying the solid phase, preferably without adding water to the mass of comminuted insect larvae, wherein further preferably during fractionation an aqueous liquid phase and a lipid-rich liquid phase are produced from the liquid phase, wherein preferably protein is removed from the liquid phase by separating the liquid components, e.g. by drying.

In general, the separation of insect larvae from water can be done by draining the insect larvae on a sieve, optionally with additional treatment of the insect larvae with warm air to dry them superficially.

In the first embodiment and in the second embodiment, the insect larvae may be heated for drying, e.g., by contacting them with hot air, steam, or hot water, e.g., for a duration of 10 s to 10 min, e.g., 30 s to 2 min, in particular until reaching a temperature of 50 to 90° C., e.g., 70° C., as a cleaning step, prior to application of pulsed electric fields or prior to comminution. The drying step is generally carried out with non-comminuted insect larvae. Therein, the temperature is, for example, the average temperature of a mass produced by comminuting the heated insect larvae, or the core temperature of the heated insects. Drying of the insect larvae by heating can be performed, for example, by treating with warm air of 50 to 90° C., for example 70 to 90° C., preferably with a flow velocity of the warm air of at most 5 m/s, preferably 1 to 3 m/s, in particular 2 m/s.

The application of pulsed electric fields is done continuously by moving the insect larvae, which in the first embodiment are present as insect larvae suspended in water or in the second embodiment as a mass of comminuted insect larvae, between at least two electrodes to which electric pulses are applied and which between them generate pulsed electric fields. The pulsed electric fields have, for example, 0.01 to 10 kV/cm and an energy input of 0.01 to 30 kJ/kg insect larvae. The pulse duration is, e.g., 5 to 50 μs, and the frequency of the pulses is 1 to 500 Hz, e.g., up to 5 Hz or up to 10 Hz. The insect larvae can be moved between the electrodes, for example, at a speed of 0 to 5 m/s, e.g., at least 1 m/s to 5 or up to 4 m/s.

Fractionation into an aqueous liquid phase and a lipid-rich liquid phase can be carried out by means of a screw press, a filter press or a decanter. Preferably, fractionation by means of a screw press is carried out at a pressure of at least 4 MPa, e.g. at least 5 MPa, to obtain a solid with a low content of water and lipids. Upon fractionation of the insect mass, e.g. by means of a screw press, the temperature of the insect mass may remain about the same during fractionation, e.g. at 5 to 30° C. or up to 25° C., or may be increased by the fractionation, e.g. from 5 to 30° C. to about 110 to 120° C. at a press pressure of 5 MPa, in particular when fractionating by means of a screw press.

The process has the advantage that the solid produced by fractionation has a low water content and that drying is efficient. It has been found that applying pulsed electric fields to the insect larvae in the first and second embodiments significantly accelerates drying of the solid obtained from fractionation, especially in hot air drying.

In general, the comminution in the first embodiment can be performed by fractionation, e.g. by pressing, in particular by means of a screw press. In this variant, the comminution of the insect larvae treated with pulsed electric fields and the subsequent fractionation are carried out in a combined step, e.g. by means of an extruder or a press.

Comminution can be carried out, for example, by cuttering, homogenization by applying pressure and subsequent relaxation through a die, for example, by extrusion, or by grinding by means of a mill.

Generally preferred the insect larvae used in the process are live ones, which moreover are not or have not been frozen. Optionally, the insect larvae may be frozen before or after cleaning, e.g., at −18° C. to −60° C., being thawed, e.g., in the first embodiment by suspending them in water, e.g., from 4 to 25° C., or in the second embodiment being thawed e.g., in air, e.g., air of from 4 to 25° C., preferably without addition of water, and comminuted, or being comminuted in the frozen state.

Drying of the solid obtained by the fractionation is preferably carried out at at least 50° C., more preferably at at least 60° C., more preferably at least 70° C. or at least 80° C., e.g. at a maximum of 120° C. or a maximum of 110° C. or a maximum of 100° C. or a maximum of 90° C. Preferably, drying is carried out by hot air drying, e.g. spray drying or fluidized bed drying.

Prior to drying, the solid can be granulated, e.g. by extrusion through a pinhole. During fractionation or in a subsequent further fractionation step the liquid phase can be separated into an aqueous phase and a lipid-rich phase, also referred to as lipid phase. Preferably, the protein contained therein is subsequently separated from the aqueous phase, e.g. by drying the aqueous liquid phase, e.g. by means of a membrane separation process, by precipitating the protein and/or by drying, preferably at at least 70° C. The protein separated from the aqueous liquid phase can be added to the solid phase and can be dried with it, or be dried separately.

The lipid phase can optionally be bleached and/or hydrogenated and used, for example, as an ingredient for food or feed.

Insect larvae include those of Hermetia illucens, Tenebrio molitor, Alphitobius diaperinus, Zophobas atratus morio, Galleria mellonella, Achroia grisella, Musca domestica, Bombyx mori, Apis mellifera, Acheta domesticus, Gryllodes sigillatus, Locusta migratoria, Schistocerca americana gregaria, Dactylopius coccus, or Periplaneta americana.

Furthermore, the invention relates to the dried protein mass obtainable by the process, the liquid phase, preferably the lipid phase separated from the liquid phase, and the protein separated from the aqueous liquid phase, wherein preferably the protein mass dried from the solid phase is combined with the protein separated from the aqueous phase, in particular is dried together. The dried protein mass is prepared from cleaned insect larvae, which have been subjected to pulsed electric fields and have been comminuted to an insect mass and subsequently been fractionated to a solid and an aqueous liquid phase, with separation of protein from the aqueous liquid phase and drying of the solid phase and the protein separated from the aqueous liquid phase. Optionally, the solid is combined with the protein separated from the aqueous liquid phase and subsequently dried. Therein, the solid phase is combined with the protein separated from the aqueous liquid phase, and these are dried together.

Preferably, the oil contained in the insect mass is provided as a separate lipid-rich liquid phase separated from the insect mass, e.g. directly from the insect mass by means of a 3-phase decanter or from a liquid phase by separating it into an aqueous liquid phase and a lipid-rich liquid phase. Therein, the oil is separate from protein, e.g. as a lipid-rich liquid phase separated from the insect mass, from which water is optionally removed.

The invention is now described in more detail by means of examples with reference to the figures, which show in

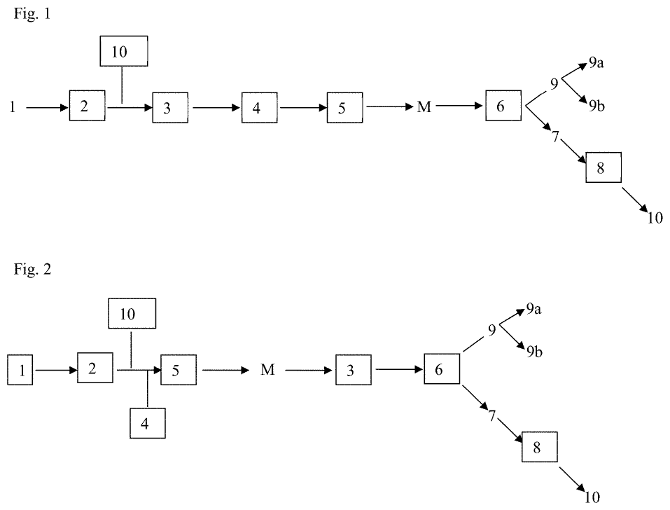

FIG. 1 schematically the process in the first embodiment,

FIG. 2 schematically the process in the second embodiment,

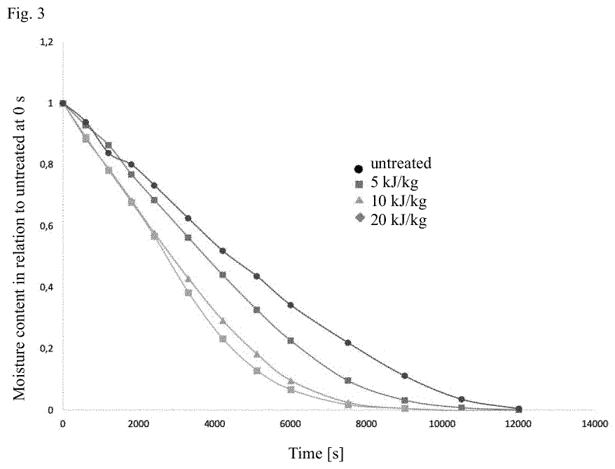

FIG. 3 the drying behavior of an exemplary protein mass.

FIG. 1 schematically shows the first embodiment of the process, in which insect larvae 1 are subjected to cleaning 2, optionally with freezing 10, and are treated in suspension in water with pulsed electric fields (PEF) 3. Therein, after freezing 10, thawing can be done during suspending in water and treating with pulsed electric fields 3. The insect larvae treated with PEF 3 and suspended in water are separated from the water 4 and subjected to comminution 5 to form an insect mass M, subsequently subjected to fractionation 6 into a solid phase 7 and a liquid phase 9, preferably in one fractionation step directly, or in a subsequent further fractionation into an aqueous liquid phase 9a and a lipid phase 9b. By drying 8 the solid phase 7 becomes the protein mass 10.

FIG. 2 schematically shows the second embodiment of the process, in which insect larvae 1 are subjected to comminution 5 after cleaning 2 and optional freezing 10, and the insect mass M thus produced is then subjected to treatment with pulsed electric fields 3. Preferably, after cleaning 2 and before or after optional freezing 10, the insect larvae are separated from water 4 with which they were brought into contact during cleaning 2. After treatment with PEF 3, the insect mass is subjected to fractionation 6 into a liquid phase 9, preferably directly into a lipid phase 9b and an aqueous liquid phase 9a, and a solid phase 7, from which the protein mass 10 is subsequently produced by drying 8.

In both embodiments, the separation 4 of water from the insect larvae can be performed by sieving, preferably followed by hot air drying, e.g. with air of a temperature of 50 to 90° C., in particular at 50, 60, 70, 80 or 90° C., e.g. in an air stream of a speed of 1 to 3 m/s on average, in particular 2 m/s.

### EXAMPLE 1: PRODUCTION OF DRIED PROTEIN MASS FROM LARVAE OF HERMETIA ILLUCENS

As an example of insect larvae, approximately 1 kg of fresh, live larvae of Hermetia illucens were suspended in cold tap water and separated from the water by means of a coarse sieve plate after a standing time of approximately 5 to 30 min with gentle stirring. The larvae were subsequently re-suspended in cold tap water and between two electrodes exposed to pulsed electric fields from at least 1 kV/cm, pulse duration from at least 5 μs, pulse frequency from 1 to 500 Hz, pulse energy 5 to 20 kJ/kg larvae.

Subsequently, the larvae were separated from the water using the coarse sieve plate and dried in an air stream of 80° C., 2 m/s. In the process, 0.65 kg of water was separated from the larvae. Subsequently, these larvae in one step were comminuted into an insect mass using a screw press at a pressure of 4 to 5 MPa and fractionated into a solid phase and a liquid phase. The solid phase had a high content of protein, chitin, carbohydrates, and traces of oil and water. The liquid phase had water with protein dissolved in it as well as lipids, which could be separated from the aqueous phase by means of a decanter. The solid phase was dried by hot air drying with an air flow starting at 2 m/s from 50° C. to 90° C.

The composition of the solid and liquid phase (with PEF) produced by the process according to the invention (with PEF) and of a solid or liquid phase produced by the otherwise identical process steps for comparison without treatment with pulsed electric fields (comparison, without PEF) are shown in the Table.

| | | Liquid | Solid | Liquid |
|---|---|---|---|---|
| | Solid | phase | comparison, | phase |
| | with | with | without | comparison, |
| | PEF | PEF | PEF | without PEF |
| mass | 0.22 kg | 0.13 kg | 0.23 kg | 0.12 kg |
| protein | 65.3% | 1-2% | 59.3% | 1-2% |
| other solids | 17% | | 17% | |
| oil | 16.7% | 96.4% | 18.5% | 96.9% |
| water | | 2-3% | | 2-3% |

This result shows that the process according to the invention by PEF treatment can produce a solid having a higher protein content and a larger liquid phase.

### EXAMPLE 2: PRODUCTION OF DRIED PROTEIN MASS FROM LARVAE OF HERMETIA ILLUCENS

As an example of insect larvae, about 1 kg of fresh, live larvae of Hermetia illucens were frozen at −18° C. and after 10 d suspended in 15° C. tap water and thawed therein and immediately subjected to pulsed electric fields from at least 1 kV/cm, pulse duration from at least 5 μs, pulse frequency from 1 to 500 Hz, pulse energy 5 to 20 kJ/kg larvae. The larvae were separated from the water with a perforated plate and by means of screw press at 5 MPa pressing pressure were comminuted and fractionated in one step at a temperature of about 20° C. The fractions obtained had a temperature of about 110 to 120° C. For comparison, the same process was carried out but without applying electrical voltage to the electrodes (comparison, without PEF). The compositions of the respective solids and of the liquid phases are shown in the table.

| | | liquid | solid, | liquid |
|---|---|---|---|---|
| | Solid, | phase, | comparison, | phase, |
| | with | with | without | comparison, |
| | PEF | PEF | PEF | without PEF |
| mass | 0.22 kg | 0.22 kg | 0.79 kg | 0.176 kg |
| protein | 16% | low | 15% | low |
| | | content, | | content, |
| | | not | | not |
| | | determined | | determined |
| other | 19% | | 15% | |
| solids | | | | |
| oil | 7% | 12% | 7% | 17% |
| water | 54.57% | 86.7% | 59.9% | 75.7% |

This result shows that pulsed electric field treatment leads to higher yield of protein in the solid.

### EXAMPLE 3: PRODUCTION OF DRIED PROTEIN MASS FROM LARVAE OF HERMETIA ILLUCENS

As an example of insect larvae, approximately 1 kg of fresh, live larvae of Hermetia illucens was suspended in cold tap water for washing and separated from it using a perforated plate, re-suspended in cold tap water and subjected to pulsed electric fields from 1 kV/cm, pulse duration from 5 μs, pulse frequency from 1 to 500 Hz larvae.

The larvae were then separated from the water using a perforated plate. The larvae were comminuted with the adhering water by means of a cutter, meat grinder or hammer mill, and the obtained insect mass was directly fractionated into three phases by means of a spindle press, alternatively by means of a 3-phase separating decanter, at a pressure of 5 MPa to obtain with this one step a lipid-rich liquid phase (oil phase), an aqueous liquid phase and a solid.

The compositions of the respective solid and liquid phases are shown in the Table.

| | | Oil | | solid, | oil phase, | |
|---|---|---|---|---|---|---|
| | solid, | phase, | aqueous | comparison, | comparison, | liquid phase, |
| | with | with | liquid phase, | without | without | comparison, |
| | PEF | PEF | with PEF | PEF | PEF | without PEF |
| mass | 0.21 kg | 0.14 kg | 0.65 kg | 0.25 kg | 0.12 kg | 0.63 kg |
| protein | 40% | 2% | 7% | 46% | 3% | 2% |
| other | 49% | 2% | low content, | 38% | 2% | low content, |
| solids | | | not | | | not |
| | | | determined | | | determined |
| oil | 3% | 93% | low content, | 10% | 93% | low content, |
| | | | not | | | not |
| | | | determined | | | determined |
| water | 8% | 3% | 93% | 6% | 2% | 98% |

This result shows that treatment with pulsed electric fields leads to a high yield of protein and lower oil content in the solid, a high yield of protein in the aqueous liquid phase, and a high yield of oil in the separated liquid oil phase. Accordingly, it is generally preferred to isolate the protein from the aqueous liquid phase.

FIG. 3 shows the relative drying behavior of the solid phases produced by the process upon application of pulsed electric fields (PEF) of 5 kJ/kg larvae, 10 kJ/kg larvae and 20 kJ/kg larvae to the larvae, respectively, in relation to a solid phase used at the beginning of drying (0 s), which was produced by the same process steps but without exposure to pulsed electric fields (untreated).

This result shows that application of pulsed electric fields significantly shortens the drying time. It was also found that, compared to the process without PEF, application of pulsed electric fields leads to a 10 vol.-% higher separation of lipids contained in the liquid phase from the insect mass.

1. A process of producing protein mass from insect larvae comprising cleaning insect larvae, applying pulsed electric fields to the insect larvae and comminuting the insect larvae to produce an insect mass, and subsequently fractionating the insect mass into a solid and at least one liquid phase, with subsequent drying of the solid to produce the protein mass.

2. The process according to claim 1, wherein the insect larvae are suspended in water and subjected to pulsed electric fields while suspended in water.

3. The process according to claim 1, wherein the insect larvae are comminuted and a mass of comminuted insect larvae is subjected to pulsed electric fields.

4. The process according to claim 1, wherein the cleaning and the application of pulsed electric fields is carried out by suspending the insect larvae in water and applying pulsed electric fields to the insect larvae suspended in water and subsequently separating the insect larvae from the water, and the insect larvae are subsequently comminuted.

5. The process according to claim 1, wherein the insect larvae are dried at least superficially before comminution and in that no water is added to the mass of comminuted insect larvae.

6. The process according to claim 1, wherein an aqueous liquid phase and a lipid-rich liquid phase are produced during fractionation.

7. The process according to claim 1, wherein the fractionation is carried out by a press with at least 4 MPa or at least 5 MPa pressure or by a decanter.

8. The process according to claim 1, wherein the fractionation is carried out by a screw press or filter press.

9. The process according to claim 1, wherein the comminution is carried out by a cutter, a mill, an extruder or a press.

10. The process according claim 1, wherein the insect laves are heated to a temperature of 50° C. to 90° C. for a period of 10 s to 10 min by contact with hot air, steam or hot water before applying pulsed electric fields or before comminution.

11. The process according to claim 1, wherein before or after cleaning the insect larvae are frozen at −18° C. to −60° C. and thawed.

12. The process according to claim 1, wherein the drying of the solid is carried out at at least 70° C.

13. The process according claim 6, wherein protein is separated from the aqueous liquid phase and is added to the protein mass.

14. The process according to claim 1, wherein the insect larvae are raw.

15. A protein mass, in particular obtainable by a process according to claim 1, wherein the protein mass is dried and produced from cleaned insect larvae which have been subjected to pulsed electric fields and been comminuted to an insect mass and subsequently fractionated to a solid and an aqueous liquid phase, with separation of protein from the aqueous liquid phase and subsequent drying of the solid and the protein separated from the aqueous liquid phase.

16. The protein mass according to claim 15, wherein the solid is combined with the protein separated from the aqueous liquid phase and subsequently dried.

17. The protein mass according to claim 15, comprising separate oil separated from the insect mass as a lipid-rich liquid phase.
